(19) United States
(12) Patent Application Publication
(10) Pub. No.: US 2017/0323160 A1
(43) Pub. Date: Nov. 9, 2017

(54) Informational Display For Moving Objects Visible Through A Window

(71) Applicant: SIEMENS AKTIENGESELLSCHAFT, MUENCHEN (DE)

(72) Inventor: ROLAND PORSCH, SPEICHERSDORF (DE)

(21) Appl. No.: 15/316,190

(22) PCT Filed: Jun. 3, 2015
(86) PCT No.: PCT/EP2015/062320

§ 371 Date: Dec. 5, 2016

(30) Foreign Application Priority Data
Jun. 3, 2014 (DE) 10 2014 210 481.5

(51) Int. Cl. G06K 9/00; G06F 17/30

(52) U.S. Cl. CPC G06K 9/00671; G06F 17/30607; G06T 2207/20068

(57) ABSTRACT

A method displays information on an object visible through a moving transparent screen and geographical coordinates are identified. The geographical coordinates of the window are used for a part of an object stored in a database, a resulting projection location on the window is identified upon projection of the object in the direction of an observer looking through the window and moving along with the window. It is identified for each of the projection locations whether the location is located within a window section of the window captured by a specified viewing angle of the observer. For those objects having a projection location located in the window section, related object information stored in the database is displayed at a distance from the identified projection location on the transparent screen. The method steps are carried out repeatedly and the object information is thus moved along together with the related object.

The invention relates to a method for displaying information about a moving object, wherein object information associated with the object and stored in a database is displayed. The invention further relates to a device for performing the method, said device comprising a screen, a computing device, a storage device in which geographical coordinates of objects are stored in associated object information, and a position identifying device for identifying the geographical coordinates of the screen.

Methods and devices are known by means of which, depending on a location at which a mobile device such as e.g. a smartphone or a portable computer is located, information about objects visible from this location or located in the vicinity of this location is shown on the mobile device. In some cases, an image of the object is shown at the same time. For example, it is customary to show images and other object information about sights that are visible from the current location of the mobile device. Until now, such a display of information has always been static. Information is shown about non-moving images, or objects that are visible on the images.

As part of the development of ubiquitous augmented reality, there is however also a need to provide associated object information about moving objects, such that these can easily be noticed by an observer. Such a display is disclosed in US 2011/0052009 A1.

Taking this as its starting point, the object of the present invention is to further improve the display of information about objects moving past a window, wherein said information is shown in the proximity of the associated object as it moves past.

This object is achieved by a method having the features in claim 1.

A further object of the invention is to provide a device for performing said method.

This object is achieved by a device having the features in the independent device claim.

Advantageous developments are the subject matter of respective dependent claims.

According to the inventive method for displaying information about at least one object visible through a moving window, a transparent screen is used as a window (step a) and the geographical coordinates of the window are identified (step b). Geographical coordinates in this case are understood to be coordinates which unambiguously describe a position of the object on Earth, e.g. degree of longitude, degree of latitude and height above mean sea level. Using these geographical coordinates of the window, a respective projection location is then identified for at least some of the objects stored in a database, said projection location resulting from a projection of the respective object in the direction of an observer looking through the window and moving along with the window (step c). It is then checked for each of the identified projection locations whether said projection location is located within that window section of the window which is captured by a specified viewing angle of the observer (step d). For those objects having a respective projection location located in the window section which is captured by the viewing angle of the observer, associated object information stored in the database is then displayed at a specified distance from the respectively identified projection locations on the transparent screen used as a window (step e). The method steps b to e are then performed repeatedly (step f). In this way, the object information is moved along with the associated object on the transparent screen used as a window.

A projection location here is understood to be a location on the window, or the transparent screen, at which the observer sees the object. Using the described method, object information about objects moving past the window can be shown at essentially any desired proximity to the associated object. The observer can continue looking in the direction of the object and receive the associated object information in a convenient manner, since said associated object information appears to move along with the respective object.

The specified distance from the respectively identified projection location can essentially be so selected as to be suitable for the respective application case. In particular, the specified distance can also assume the value of zero, such that a display of object information can take place directly at the associated projection location.

The database advantageously holds at least the geographical data relating to the objects. The calculation of the projection locations can then be limited to those objects stored in the database whose geographical coordinates are so close to the geographical coordinates of the window that they are likely to be recognizable through the window. For example, the calculation of the projection locations may be limited to those objects located in a semicircle which has a radius of five kilometers and is adjacent to the surface of the window. The effort of performing the method can be reduced thereby, wherein the computing effort of installed computing devices and hence their power consumption can be reduced in particular.

For those objects whose respective projection location is located in a window section which is captured by the viewing angle of the observer, and before the method step e is performed, the projection height of the respective object when projected at the respective projection location is advantageously calculated on the basis of heights of these objects as stored in the database. The method step e is then performed for only those of these objects whose projection height exceeds a specified minimum height. The specified minimum height is so selected in the respective application case that the object appears large enough to be noticed by the observer. The effort of performing the method can be further reduced in this way, since the computing effort and hence ultimately the energy requirement for performing the method is reduced for objects which the observer would not notice in any case. The described limitation of the performance of the method step e to objects whose projection height exceeds the specified minimum height obviously only applies to one method loop initially. When the next method loop is executed as per method step f, it is again checked whether the specified minimum height is exceeded. The display of the associated object information may be larger or smaller, depending on the projection height of the associated object. This means that the associated object information can be scaled according to the projection height of the associated object. This allows an adequate display area to be provided for object information about other objects whose projection height is greater.

For those objects whose respective projection location is located in the window section which is captured by the viewing angle of the observer, and before the method step e is performed, it is preferably checked whether an observer's view of the respective object is inhibited by other objects or terrain layouts stored in the database. For example, the geographical coordinates stored in the database for the various objects can be used for this purpose. Topological information stored in the database can likewise be used for this purpose. The method step e is then performed for only those objects which are free of any such inhibited view and can therefore be noticed by the observer. As in the case of the embodiment variant described above, the performance of the method step e here is limited to the cited objects in the respective method loop only. In the next method loop, the requirements for omission of the method step e for the relevant object are checked again. The method variant described above allows object information to be displayed for only those objects which can also be noticed by the observer. Moreover, as described above, by virtue of limiting the performance of the method step e to selected objects, the effort required to perform the method can be further reduced.

In a further method variant, for those objects whose respective projection location is located in the window section which is captured by the viewing angle of the observer, and before the method step e is performed, it is checked whether an observer's view of the respective object is inhibited by other objects or terrain layouts stored in the database. In the event that the view is inhibited thus, an image of the object is displayed at its identified projection location on the transparent screen used as a window. In this way, objects and in particular sights can be brought to the attention of the observer when they are in the vicinity but cannot be discerned with the naked eye.

According to the invention, provision is made for identifying a window velocity at which the window or the transparent screen is moving. On the basis of this window velocity, a respective object information velocity is then identified for at least some of the objects stored in the database. This respective object information velocity represents a velocity at which the associated object information should move across the transparent screen. The method step e is then performed for only those objects whose object information velocity is less than a specified maximum velocity. It is possible thus to prevent a display of object information which would have to move so fast on the transparent screen that it would either be impossible for the observer to discern or impossible to achieve using the available switching times of the transparent screen. It is also possible again to reduce the effort required to perform the method. As explained above in connection with the previously described method variants, the limitation of the method step to objects whose object information velocity is less than the specified maximum velocity is only continued for one method loop. The identification of the object information velocity can consist in an approximate estimation of the object information velocity, which can be made on the basis of the distance of the object from the window. The associated object information velocity is preferably identified for only those objects whose respective projection location is located in the window section which is captured by the viewing angle of the observer. The effort of performing the method can be reduced thus.

It is advantageously possible to achieve a further reduction in the effort required to perform the method by virtue of identifying in method step c the projection location of only those objects whose object information velocity is less than the specified maximum velocity.

According to an advantageous method variant, at nighttime or during poor visibility of those objects whose respective projection location is located in the window section which is captured by the viewing angle of the observer, an image of the respective object is displayed at the respectively identified projection location on the transparent screen used as a window. In this way, it is possible even in poor visibility for the observer to discern an object, e.g. a sight, at the location at which it would be recognizable in better visibility.

The display of the image of the respective object can be omitted if the view of this object is inhibited. This prevents the observer from receiving a false impression of the position of the object concerned.

In practice, it has proven satisfactory to use a window of a rail-borne vehicle, a coach or other motor vehicle as a moving window. The window panes of the rear seats are preferably used as moving windows in the case of motor vehicles.

The method is advantageously executed for each row of vehicle seats that is arranged perpendicular to a direction of travel. The observer is therefore the passenger who is sitting on a seat in this row of seats. The performance of the method for a row of seats means that an identical viewing angle, identical projection locations and an identical window section are assumed for all of the seats in this row of seats. The method is therefore effectively performed for one seat in this row of seats, and the results are reproduced for all of the seats in this row of seats. The term vehicle in this case essentially includes all types of land-based, waterborne and airborne vehicles. This method variant firstly allows a reduction in the effort required to perform the method. Secondly, it prevents only a very small window section being available to the respective observer, which would be the case if it was necessary to provide a window section for each seat in a row of seats and for this window section to not overlap with window sections assigned to other seats in this row of seats.

The performance of the method is preferably limited to those rows of vehicle seats in which at least one observer is sitting. As stated above, said observer is normally a passenger. This prevents the method from being performed for completely unoccupied rows of seats. It is thereby possible further to reduce the effort of performing of the method.

The device according to the invention has a screen, a computing device and a storage device in which geographical coordinates of objects and associated object information are stored. A position identifying device for identifying the geographical coordinates of the screen is also provided. In order to realize a device for performing the method according to the invention, it is proposed that the screen should be transparent and provided as a window, and that the computing device should be so configured as to identify the projection location that is produced on the screen when an object is projected onto the screen. A position identifying device can be e.g. a satellite-based positioning system, e.g. a system which works using signals from the Global Positioning System (GPS), often referred to as a GPS receiver.

The storage device preferably includes terrain layouts. It is then possible to check whether the view of an object is inhibited by terrain layouts.

The computing device is advantageously so configured as to calculate projection heights of the objects. With the help of these projection heights, it is possible both to scale the display of the object information to a suitable size and to reduce in the manner described above the effort of performing the method according to the invention.

An image of the object is advantageously stored in the storage device as associated object information for each object. In the event of poor visibility, this can be displayed on the transparent screen and brought to the attention of an observer, in particular a passenger, in the manner described above.

A device for measuring the window velocity is provided. The measured window velocity can be used for the purpose of identifying the geographical coordinates of the screen.

The computing device is further so configured as to identify for objects stored in the storage device an object information velocity at which, when the method is performed, the associated object information should move across the transparent screen used as a window. Inter alia a window velocity ascertained by the device for measuring the window velocity can be used for this purpose. The described configuration of the computing device for identifying the object information velocity makes it possible, in the manner described in connection with the method, to reduce the effort of performing the method and to avoid the display of object information which can barely be discerned by the observer.

It has proven useful in practice to embody the screen as a window of a vehicle, in particular a window of a rail-borne vehicle, a coach or a motor vehicle, since there is often an increased information requirement for travelers on journeys.

The properties, features and advantages of the invention as described above and the manner in which these are realized become clearer and easier to understand in the context of the following description of the exemplary embodiments, these being explained in greater detail with reference to the drawings. Where appropriate, identically functioning elements are denoted herein by identical reference signs. The invention is not restricted to the exemplary embodiments shown in the figures, or to the functional features therein. Both the foregoing description and the following description of the figures contain numerous features which are in some cases severally combined in the dependent sub claims. These and other features disclosed in the foregoing and in the following description of the figures may nonetheless also be considered individually and combined to form further suitable combinations by a person skilled in the art. In particular, these features may be combined with the method and/or the device specified in the independent claims, either individually in each case or in any suitable combination.

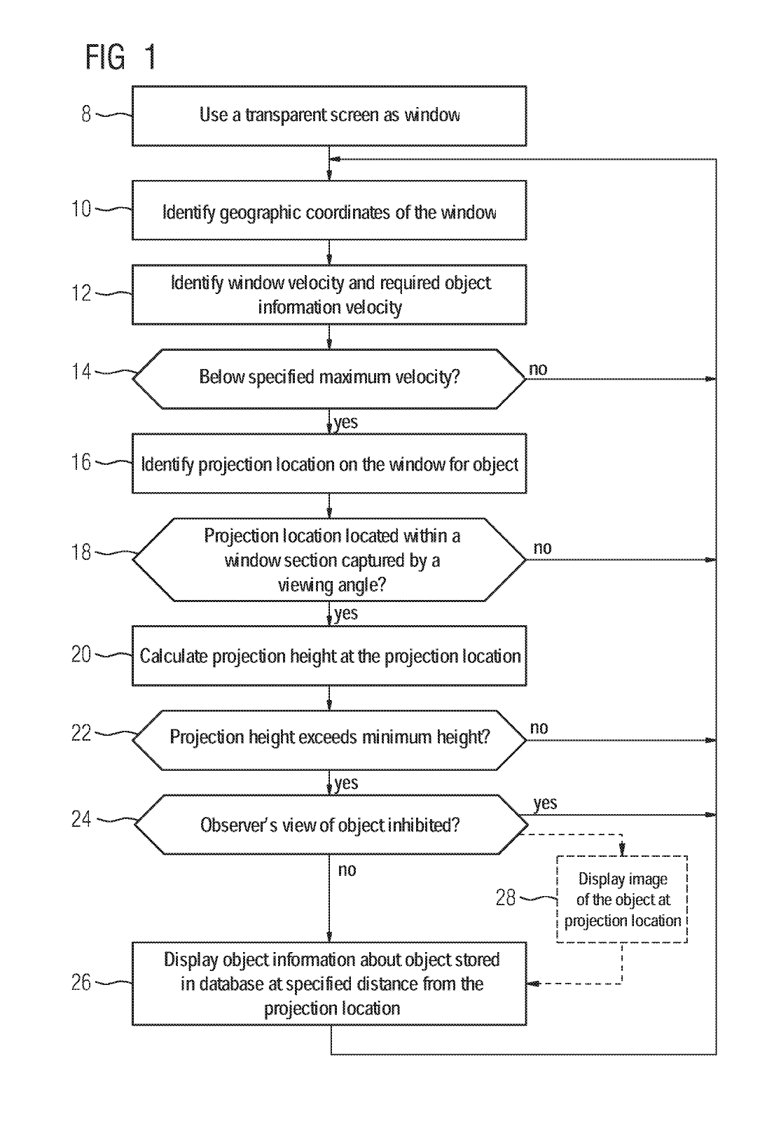

FIG. 1 shows a block diagram of a first exemplary embodiment of the method according to the invention,

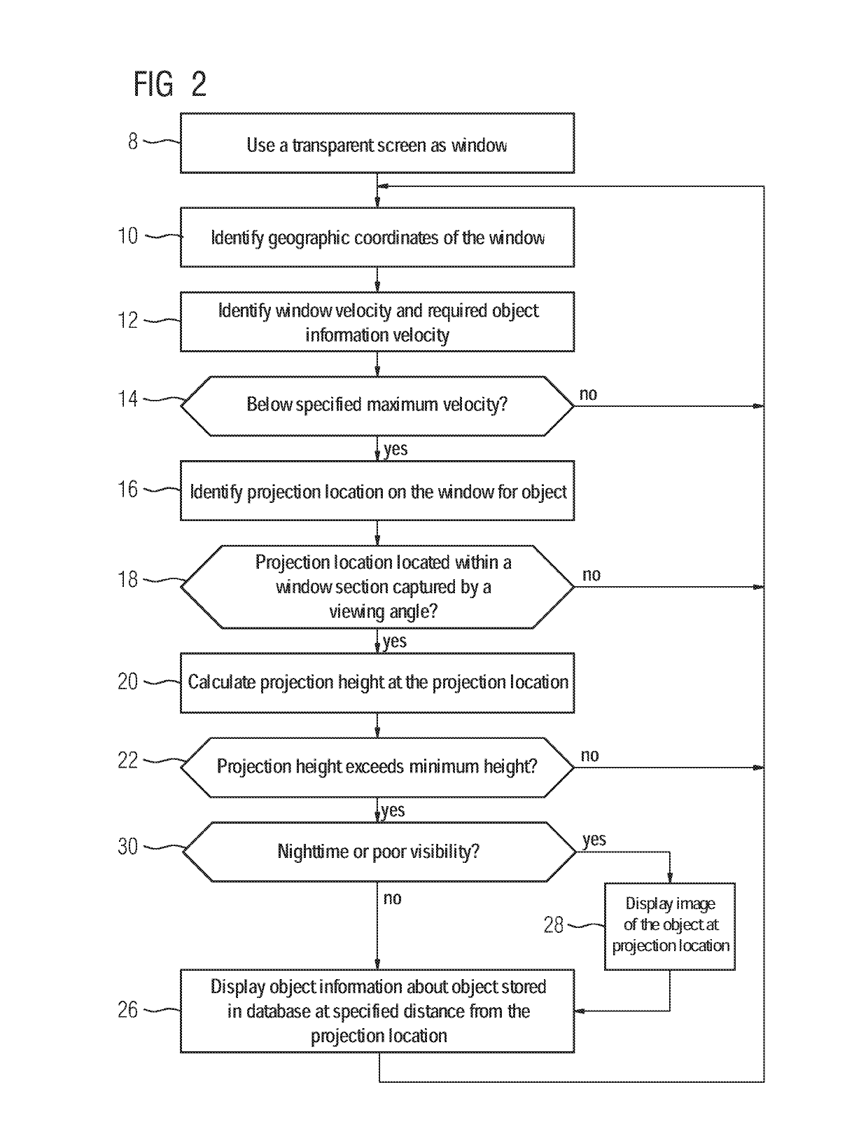

FIG. 2 shows a block diagram of a second exemplary embodiment of the method according to the invention,

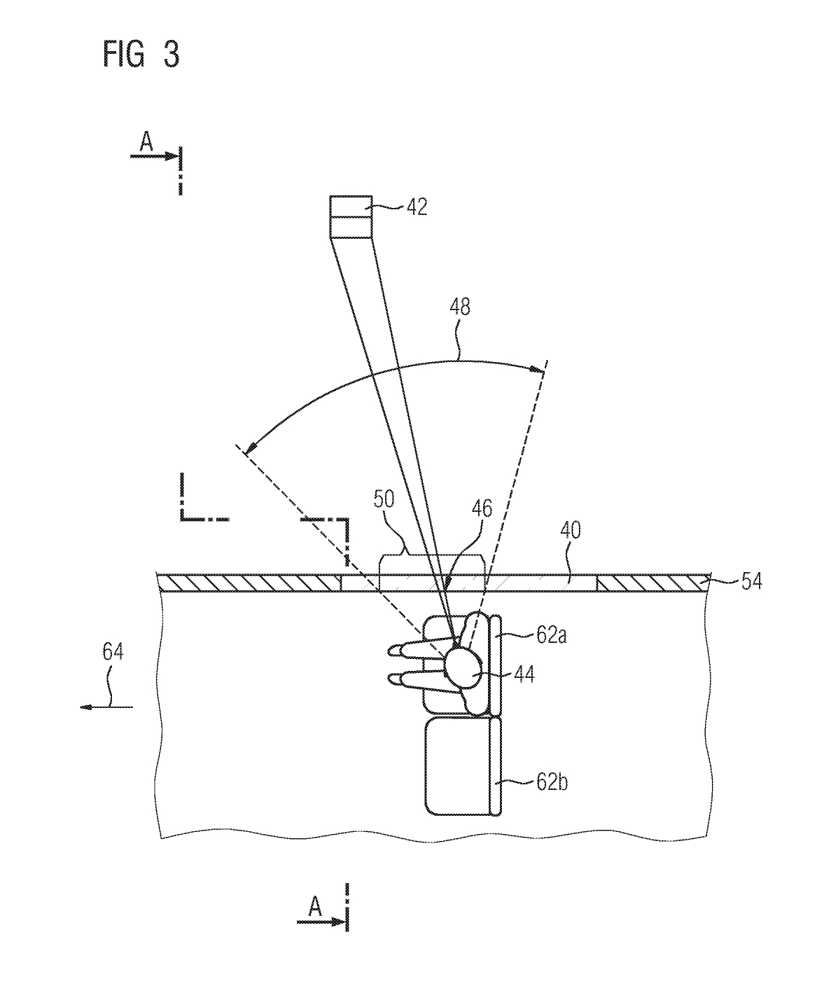

FIG. 3 shows a partial schematic diagram of an open view onto a train carriage in which the method according to the invention is used,

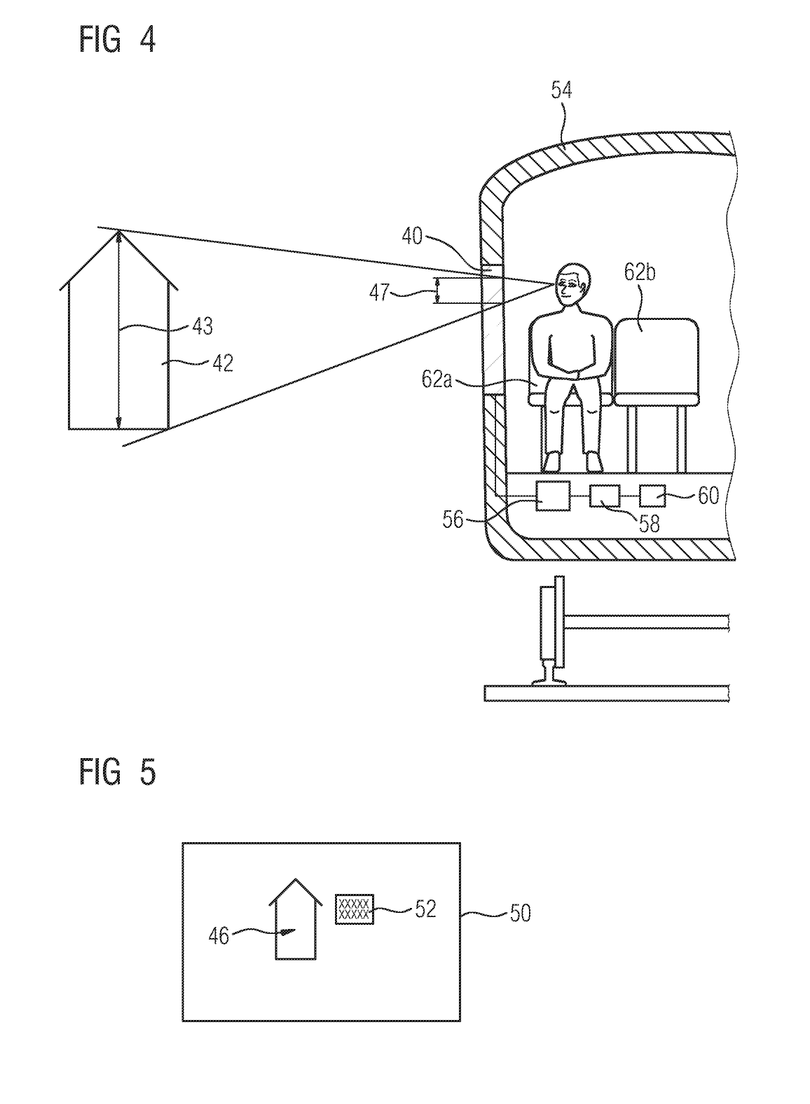

FIG. 4 shows a schematic diagram of a vertical section through the partial diagram as per FIG. 3 along the intersection line A-A, and

FIG. 5 shows a schematic diagram of the display of object information on the transparent screen.

FIG. 1 shows a block diagram of a first exemplary embodiment of the method according to the invention. This is explained in greater detail below with reference to the partial schematic diagrams of a train carriage 54 in the FIGS. 3 and 4. In the method according to FIG. 1, a transparent screen 40 is used 8 as a window. Any reference to the window in the following is therefore understood to signify the transparent screen 40.

The geographical coordinates of the window 40 are identified 10 first. A window velocity of the transparent screen 40 used as a window is then identified 12, together with object information velocities at which object information that is associated with objects should move across the transparent screen 40. It is then checked 14 whether the object information velocity identified for the respective object is less than a specified maximum velocity. If this is not the case, no display of object information takes place for this object. Instead of this object, the next loop of the method is started, starting again with the identification 10 of the geographical coordinates of the window 40.

If the specified maximum velocity for the observed object stored in a database is not reached, however, an associated projection location is identified 16 using the identified geographical coordinates of the window 40, said projection location resulting from a projection of the respective object in the direction of an observer 44 looking through the window 40 and moving along with the window 40. In the diagrams according to FIGS. 3 and 4, this is shown in a schematic and exemplary manner for an object 42, upon projection of which a projection location 46 on the transparent screen 40 is identified. Corresponding projection locations are identified for all those objects stored in the database whose associated object information velocity is less than the specified maximum velocity.

During the further course of the method, for each of the identified projection locations and in particular the projection location 46 of the object 42, it is checked 18 whether said projection location is located within that window section 50 of the window 40 which is captured by a specified viewing angle 48 of the observer 44. In this case, the viewing angle is selected and specified in a suitable manner according to the respective circumstances of the specific case, e.g. the structure of a vehicle. For those objects whose projection location is located outside the window section 50, the current method loop is terminated. They are taken into consideration again when the next method loop is performed. For those objects whose projection location is located within the window section 50, provision is then made for calculating 20 their projection height at the respective projection location. Accordingly, the projection height 47 at the projection location 46 is calculated 20 for the object 42, whose projection location 46 is located within the window section 50, using a height 43 of the object 42 as stored in the database.

It is then checked 22 whether the respectively calculated projection height, in particular the projection height 47 of the object 42, exceeds a specified minimum height. The minimum height is selected for the respective application case such that, if this minimum height is exceeded, it can be assumed that the object can be recognized by the observer on the window or the transparent screen 40. For those objects whose projection height does not exceed the minimum height, the method loop is terminated. They are taken into consideration again when the next method loop is performed. However, for those objects whose projection height exceeds the minimum height, it is checked 24 whether an observer's 44 view of the respective object is inhibited by other objects or terrain layouts stored in the database. If this is the case, the method loop is terminated for the object concerned. This object is then taken into consideration again in the next method loop. If the view is not inhibited, object information stored in the database and relating to this object is displayed 26 at a specified distance from the projection location.

Accordingly, in the case of the object 42 shown in the FIGS. 3 and 4, whose projection height 47 exceeds the minimal height, it is checked whether the observer's 44 view of the object 42 is inhibited by other objects or terrain layouts. This is not the case here. Consequently, as schematically shown in FIG. 5, object information 52 stored in the database and relating to the object 42 that can be recognized by the observer 44 at the projection location 46 in the window section 50 is displayed at a specified distance from the projection location 46. The transparent screen 40 is activated in a known manner for this purpose.

The object information may essentially comprise any information that can be shown, in particular text, graphical representations or images. The respective distance is selected as appropriate for the respective application case, such that no relevant objects are concealed by the object information if possible. The display of the object information and/or the specified distance can advantageously be scaled as a function of the calculated projection height 47 of the object 42. This obviously applies not only to the object 42 shown by way of example, but essentially to all objects stored in the database and taken into consideration when using the method.

With regard to those objects for which it was established in the context of the checking step 24 that the observer's 44 view of these objects is inhibited, it is possible to perform an optional method step 28, shown by a broken line in FIG. 1. This provides for displaying 28 an image of the object concerned, said image being stored in the database, at the projection location of this object. As explained above, it is possible by this means to make the observer aware of objects which would not otherwise be visible. As shown in FIG. 1, in the case of such images which are displayed 28 at the projection location of the object concerned, the object information stored in the database and relating to this object is also displayed 26 at a specified distance from the projection location, such that this additional information is also made available to the observer.

The exemplary embodiment of the method according to the invention shown in FIG. 2 differs from that in FIG. 1 in that checking 30 for nighttime or poor visibility takes place instead of checking 24 whether the observer's view of the object is inhibited. If this is the case, an image of the object concerned is displayed 28 at the projection location of the object in addition to the object information stored for this object. However, if daytime or satisfactory visibility applies, only the object information stored in the database and relating to the object concerned is displayed 26 at the specified distance from the projection location.

The checking 30 for nighttime or poor visibility and the corresponding display 28 of images of the objects at the respective projection locations can be integrated into the method shown in FIG. 1. Conversely, it is also possible to include the check 24 whether the observer's view of the objects is inhibited by other objects or terrain layouts in the exemplary embodiment according to FIG. 2.

The exemplary embodiments of the method as shown in FIGS. 1 and 2 are executed for each row of seats that is arranged perpendicular to a direction of travel. With reference to the diagrams in FIGS. 3 and 4, this means that the methods are executed for a row of seats composed of seats 62a and 62b, and any other seats that are present in this row. This row of seats 62a, 62b is arranged perpendicular to a direction of travel 64 of the train carriage 54. The methods are preferably executed for only those rows of seats in which at least one observer 44 is sitting. This is the case for the row of seats 62a, 62b. Consequently, the same viewing angle 48 is specified, identical projection locations 46 and an identical window section 50 are produced for each observer sitting in the row of seats 62a, 62b. The methods according to FIG. 1 or FIG. 2 are therefore effectively performed for one seat in this row of seats 62a, 62b, and the results are reproduced and used for all of the seats in this row of seats.

An exemplary embodiment of the device according to the invention is schematically shown in FIG. 4 and integrated into the train carriage 54. This device comprises the transparent screen 40, a computing device 56 and a position identifying device 60 for identifying the geographical coordinates of the transparent screen 40 or the window 40. The computing device 56 is so configured as to identify the projection locations that are produced on the screen 40 when an object, e.g. the object 42, is projected onto the transparent screen 40, e.g. the projection location 46 of the object 42. Provision is also made for a storage device 58, in which geographical coordinates of objects and associated object information are stored. In particular, the geographical coordinates of the object 42 and its associated object information 52 are stored there. The storage device 58 therefore contains the database which is accessed when performing the method shown in FIGS. 1 and 2. The terrain layouts that are required when checking 24 whether the observer's 44 view of an object is inhibited are also stored in the storage device 58 accordingly. The images that are required in order to display 28 images of the objects are likewise stored in the storage device 58.

The computing device 56 is so configured as to perform the checking steps 14, 18, 22, 24 and 30 and the identification and calculation steps 10, 12, 16 and 20 in conjunction with the storage device 58 and the position identifying device 60. For the purpose of realizing the display steps 26 and 28 of the method according to FIGS. 1 and 2, the computing device 56 is also connected to the transparent screen 40.

Although the invention is illustrated and described above with reference to preferred exemplary embodiments, the invention is not restricted by the examples disclosed herein, and other variations may be derived therefrom by a person skilled in the art without thereby departing from the scope of the invention.

1-12. (canceled)

13. A method for displaying information about at least one object visible through a moving window, which comprises the steps of:
a) providing a transparent screen as the moving window;
b) identifying geographical coordinates of the moving window;
c) identifying a window velocity at which the moving window is moving;
d) identifying respective object information velocity for at least some objects stored in a database on a basis of the window velocity at which associated object information should move across the transparent screen;
e) using the geographical coordinates of the moving window to identify a respective projection location on the moving window for resulting in a projection of a respective object in a direction of an observer looking through the moving window and moving along with the moving window for at least some of the objects stored in the database;
f) checking for an identified projection location if the identified projection location is disposed within that window section of the moving window which is captured by a specified viewing angle of the observer;
g) displaying the associated object information stored in the database at a specified distance from the identified projection location on the transparent screen used as the moving window for the objects having the respective projection location disposed in the window section which is captured by the specified viewing angle of the observer, and performing the method step g) only for the objects having the respective object information velocity being less than a specified maximum velocity; and
h) performing repeatedly the method steps b) to g), whereby the associated object information is moved along with the object on the transparent screen used as the moving window.

14. The method according to claim 13, wherein for the objects having the respective projection location disposed in the window section which is captured by the viewing angle of the observer, and before the method step g) is performed, calculating a projection height of the respective object when projected at the respective projection location on a basis of heights of the objects as stored in the database, and the method step g) is then performed for only the objects having the projection height that exceeds a specified minimum height.

15. The method according to claim 13, wherein for the objects having the respective projection location disposed in the window section which is captured by the specified viewing angle of the observer, before the method step g) is performed, it is checked whether a view of the observer of the respective object is inhibited by other objects or terrain layouts stored in the database, and the method step g) is then performed for only the objects which are free of any such inhibited view.

16. The method according to claim 13, wherein for the objects having the respective projection location disposed in the window section which is captured by the viewing angle of the observer, before the method step g) is performed, it is checked whether a view of the observer of the respective object is inhibited by other objects or terrain layouts stored in the database, and in an event that the view of the object having the projection location disposed in the window section captured by the observer is inhibited, an image of the object at the identified projection location is displayed on the transparent screen used as the moving window.

17. The method according to claim 13, wherein in the method step e), identifying the respective projection location for only the objects having the respective object information velocity being less than the specified maximum velocity.

18. The method according to claim 13, which further comprises displaying an image of the respective object at the identified projection location on the transparent screen used as the moving window at nighttime or during poor visibility of the objects having the respective projection location disposed in the window section captured by the specified viewing angle of the observer.

19. The method according to claim 18, which further comprises omitting a display of the image of the respective object if the view of the respective object is inhibited.

20. The method according to claim 13, which further comprises using a window of a rail-borne vehicle, a coach or other motor vehicle as the moving window.

21. The method according to claim 13, which further comprises executing the method for each row of vehicle seats disposed perpendicular to a direction of travel in a vehicle, wherein the performance of the method is limited to rows of vehicle seats in which at least one observer is sitting.

22. A device for displaying information about at least one object visible through a moving window by performing the method according to claim 13, the device comprising:
a screen configured as to be transparent and is the moving window;
a computing device;
a storage device storing geographical coordinates of objects and associated object information;
a position identifying device for identifying the geographical coordinates of said screen, one of said computing device and said position identifying device configured for measuring a window velocity; and
said computing device configured as to identify a projection location that is produced on said screen when the object is projected onto said screen, said computing device further configured to identify, for the objects stored in said storage device, an object information velocity at which, when the method is performed, associated object information should move across said screen.

23. The device according to claim 22, wherein an image of the object is stored in said storage device as the associated object information for each of the objects.

24. The device according to claim 22, wherein said screen is a window of a vehicle.

25. The device according to claim 22, wherein said screen is a window of a rail-borne vehicle, a coach or a motor vehicle.
